(19) United States
(12) Patent Application Publication
(10) Pub. No.: US 2016/0330577 A1
(43) Pub. Date: Nov. 10, 2016

(54) METHOD FOR AUTOMATED ASSOCIATION TO AND DELIVERY OF LOCATION-SPECIFIC DATA TO SMART MOBILE DEVICES

(71) Applicant: WolfGIS, LLC, Pell City, AL (US)

(72) Inventor: John Michael Golden, Pell City, AL (US)

(73) Assignee: WolfGIS, LLC, Pell City, AL (US)

(21) Appl. No.: 15/146,542

(22) Filed: May 4, 2016

Related U.S. Application Data
(60) Provisional application No. 62/156,553, filed on May 4, 2015.

(51) Int. Cl. H04W 4/02; G06F 17/30; H04L 29/08

(52) U.S. Cl. CPC H04W 4/02; H04L 67/02; G06F 17/3087; G06F 17/30241; H04M 2250/10

(57) ABSTRACT

A geo-located data system is described with inherent properties for allowing users to request and receive specific subsets of geo-located data from a known provider source.

### CROSS-REFERENCES TO RELATED APPLICATIONS

This application claims the benefit of U.S. Provisional Application No. 62/156,553, filed May 4, 2015, which is incorporated herein by reference in its entirety.

### FIELD OF THE INVENTION

The present invention is generally directed to the transmission of specific subsets of geo-located data using geo-positioning software and web communication services of smart mobile devices or custom, purpose built location devices.

### BACKGROUND OF THE INVENTION

Part of the convergence of work, communication, play, and entertainment on smart mobile devices, including but not limited to, phones and pads, is the growing availability of applications (software) for those devices which allow working with large and varied data sets in the field on such devices in every imaginable land-based enterprise. Land or location-based data may be taken into the field and utilized via these devices running such applications, and additional data may be also be collected in the field.

A data set example is Geographic Information System (GIS) data, which is map based, geo-referenced data. A GIS data file may depict all of the parcels in a county, all of the capped oil wells in a state, a town's water and sewage system, or any other type of data which may be geo-referenced and thus displayed precisely over a map. Further, a GIS data file may contain additional layers of data referenced to each feature in the primary displayed file. One example would be a list of all the information the creator of a county parcel GIS file chose to include about each property, such as Property ID number, Tax ID number, size, zone, owner, etc. Another example would be a list of the type, age, post type, exact wording, material, etc., for a GIS dataset depicting the location of all road signs in a county. There are other existing and possible data set types which may be used in this way.

Such data sets are often quite large in terms of computing memory and over-the-air data transmission times. For instance, over 50 Mb size is common. Transmission to, and processing via the Application, such volumes of data in smart portable devices is a serious issue, to the point of rendering usage of the data impractical due to cost and memory limitations. Therefore, a need exists in the art for a more efficient way to request and receive data sets at a lower cost to users.

### SUMMARY OF THE INVENTION

This invention uses on-board location services and web communication services of smart mobile devices to allow users to request specific subsets of geo-located data from a provider source based on location and a bounding box.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

Given that transmission of a full GIS or other geo-located data file from a known provider source, such as an internet connected server, may not be possible due to total transmission time required and/or receiving device memory/storage limitation, this invention overcomes both issues by identifying desired small subsets of the total geo-located data file, for quick transmission with no memory or storage issues.

More specifically, the invention solves the large file size and high cost problems by allowing a user to request and receive only a specific subset of the full data set. The user of the geo-located data set(s) communicates his location based on a bounding box and desired amount of data around the location to a provider source which is able to identify and send the specific data requested.

The system consists primarily of a smart mobile device, a provider source, a transmission method, and an on-board global positioning system (GPS). Said system allows the transmission of a specific subset of data requested by a user from a provider source using an application on the user's mobile device.

The preferred embodiment of the smart mobile device has on-board GPS location services and a cellular data plan or a custom built location device incorporating those functions and able to run applications. These smart mobile devices could comprise, without limitation, phones, pads or custom, purpose built location devices.

In the preferred embodiment of the system, while running the application in the smart mobile device, the user identifies a desired point or bounding box and requests the geo-located data files associated with that desired point or bounding box via the smart mobile device.

Geo-located data such as GIS files inherently contain location data. Any number of sorting algorithms may be applied to these types of data sets to compare each feature's location to the user's location and amount of data input. As GIS/geo-located data includes latitude and longitude information about the visible, graphical data, the method of obtaining a desired subset of the data is based on location as defined by latitude and longitude of the user.

The user's location is comprised of the latitude and longitude of the device's location based on the on-board GPS services as a single point representing either their location, or a chosen location on a map, and is sufficient to correlate to the GIS/geo-located file's latitude/longitude data, which is typically in a searchable database format organized around the features in the file. In that case, any GIS/geo-located feature in that data file which includes the user's location would be returned in response to the database search.

Alternatively, and also contemplated in the preferred embodiment, the latitude/longitude driven database search can be via a scalable circle or polygon wherein the request by the user is centered on his or her chosen location, which is easy to define, and would be the bounding box of the search. There are a variety of algorithms for determining if a specific latitude/longitude falls within a bounding box defined by the latitude/longitude and associated information, such as the radius of a circle with its center at that latitude and longitude. The GIS/geo-located data file database search would then be based on identifying any feature with latitude/longitude location data that falls within the bounding box.

In the preferred embodiment, after the user requests the location database search, the application connects to the server of the GIS/geo-located data file via cellular or Wifi and presents the search request to the provider source, a secure server connected to the Internet.

The server receives and executes the search request and returns the search results containing only the subset of the data set conforming to the request of the user after the application requests transmission of the resulting subset of the file.

The user then receives and is allowed use of the small subsets of the total geo-located data file via the smart mobile device application quickly and easily.

There are other processes possible for identifying a desired subset of GIS and geo-located data files. GIS/geo-located files also include a table of data about each feature in the file. The first column is a list of the categories of data, common to every feature in the file. The second column is the specific data per category for a specific feature in the file. Therefore, it is also possible to search for a subset of the total data file based on one or more categories of this feature data, which is also stored in a searchable database.

For example, if one knew that Owner Name was a category in a GIS/geo-located data file, and one could provide the exact Owner Name correlating to one or more features in that file, a search would return just the features with that Owner Name.

Potential embodiments of the invention also include numerous interface possibilities between the user and database in terms of communicating and executing the data request.

An example of the use the invention is as follows: A state land manager is investigating a large potential landslide in the field. The manager determines that he needs to add a GIS data file mapping water tables and hydrology to the layers of data already being displayed on his smart mobile device, and he can contact a provider of such data sets. There is no street address or other data to communicate his location to the provider. He doesn't need the complete regional dataset, only the local subset of it. The full data set is larger than can be transmitted to his device in the field reliably, and is too large for the memory of his smart portable device.

Another example of the invention in use includes a real estate broker cruising rural roads looking for property to invest in. The broker identifies a prospective property, but needs to get an idea of the terrain the property encompasses, and the arrangement of the adjacent properties, in order to determine if he wishes to invest further time in it. He can obtain GIS parcel shapefiles by specific property to display on his smart mobile device from a vendor of such, but there is no address or other location information available. The data sets he desires are small, easy to transmit and process by the application on his smart mobile device, but he has no way to define which parcel data set(s) he wishes to purchase. He only needs data immediately local to his position.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other provider source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

I hereby claim:

1. A method of associating and transmitting geo-located data comprising:
a. a smart mobile device;
b. a provider source;
c. a transmission method; and
d. an on-board global positioning system (GPS).

2. The smart mobile device of claim 1 wherein said smart mobile device is capable of running software applications.

3. The provider source of claim 1 wherein said provider source is an Internet connected server.

4. The transmission method of claim 1 wherein said transmission method is Wifi.

5. The transmission method of claim 1 wherein said transmission method is cellular.

6. A method of associating and transmitting geo positional data comprising:
a. a user requesting a geo-located data file database search via a smart mobile device;
b. the smart mobile device connecting to a provider source of the geo-located data and presenting the search request to the provider source;
c. the provider source receiving and executing the search request and returning the search results containing only a subset of the of the geo-located data file conforming to the request of the user; and
d. the user receiving the requested subset of the geo-located data file via the smart mobile device.

7. The provider source of claim 6 wherein said provider source is an internet connected server.

8. The smart mobile device of claim 6 wherein said smart mobile device is capable of running software applications.
